(19) United States
(12) Patent Application Publication
(10) Pub. No.: US 2025/0055305 A1
(43) Pub. Date: Feb. 13, 2025

(54) CHARGING CIRCUIT, ELECTRONIC DEVICE AND CHARGING SYSTEM

(71) Applicant: GUANGDONG OPPO MOBILE TELECOMMUNICATIONS CORP., LTD., Dongguan (CN)

(72) Inventors: Hongguang GUO, Dongguan (CN); Jianguo LI, Dongguan (CN); Xuan LUO, Dongguan (CN); Chen TIAN, Dongguan (CN); Jialiang ZHANG, Dongguan (CN)

(73) Assignee: GUANGDONG OPPO MOBILE TELECOMMUNICATIONS CORP., LTD., Dongguan (CN)

(21) Appl. No.: 18/927,817

(22) Filed: Oct. 25, 2024

Related U.S. Application Data
(63) Continuation of application No. PCT/CN2022/142485, filed on Dec. 27, 2022.

(30) Foreign Application Priority Data
Jun. 20, 2022 (CN) 202210698490.1

(51) Int. Cl. H02J 7/02; H02M 1/00; H02M 7/04; H02M 7/219

(52) U.S. Cl. CPC H02J 7/02; H02M 1/0064; H02M 1/0067; H02M 7/05; H02M 7/219

(57) ABSTRACT

A charging circuit is provided. The charging circuit is applied to an electronic device. The charging circuit includes a resonant circuit and a voltage transformer circuit. The resonant circuit is configured to convert a received DC signal into an AC signal. The voltage transformer circuit includes a primary winding and a secondary winding. The primary winding is connected to an output end of the resonant circuit. The primary winding is coupled to the secondary winding. The voltage transformer circuit is configured to transform a first voltage of the AC signal into a second voltage through the primary winding and the secondary winding. The second voltage is configured to supply electrical energy to an electricity-consuming apparatus. The second voltage is less than or equal to the first voltage.

### CROSS REFERENCE TO RELATED APPLICATIONS

This application is a continuation of International Patent Application No. PCT/CN2022/142485, filed Dec. 27, 2022, which claims priority to Chinese Patent Application No. 202210698490.1, filed Jun. 20, 2022, both of which are herein incorporated by reference in their entireties.

### TECHNICAL FIELD

The present disclosure relates to the field of electronic technologies, and in particular to a charging circuit, an electronic device, and a charging system.

### BACKGROUND

With the continuous enhancement of functions of the smart terminals in recent years, users' demands for the charging speed of the smart terminals keep increasing accordingly. The output power of adapters has risen, from the previous range of 5 watts (W) to 20 W, to a range over 65 W. The input voltage and input current of the smart terminals would correspondingly increase as the output power from external power supply ends increases. The increase in voltage and current would place higher demands on the reliability of internal devices of the smart terminals. Therefore, how to ensure the reliability of the devices while enhancing the charging power is a technical problem that needs to be solved urgently.

### SUMMARY OF THE DISCLOSURE

According to a first aspect of the present disclosure, a charging circuit is provided. The charging circuit is applied to an electronic device. The charging circuit includes a resonant circuit and a voltage transformer circuit. The resonant circuit is configured to convert a received DC signal into an AC signal. The voltage transformer circuit includes a primary winding and a secondary winding. The primary winding is connected to an output end of the resonant circuit. The primary winding and the secondary winding are coupled to each other. The voltage transformer circuit is configured to transform a first voltage of the AC signal into a second voltage through the primary winding and the secondary winding. The second voltage is configured to supply electrical energy to an electricity-consuming apparatus. The second voltage is less than or equal to the first voltage. The resonant circuit is configured to operate at a constant resonant frequency.

According to a second aspect, an electronic device is further provided. The electronic device includes the charging circuit and an electricity-consuming apparatus. The charging circuit includes the resonant circuit and the voltage transformer circuit. The resonant circuit is configured to convert the received DC signal into the AC signal. The voltage transformer circuit includes the primary winding and the secondary winding. The primary winding is connected to the output end of the resonant circuit. The primary winding and the secondary winding are coupled to each other. The secondary winding is connected to the electricity-consuming apparatus. The voltage transformer circuit is configured to transform the first voltage of the AC signal into a second voltage through the primary winding and the secondary winding. The second voltage is configured to supply the electrical energy to the electricity-consuming apparatus. The second voltage is less than or equal to the first voltage. The resonant circuit is configured to operate at a constant resonant frequency.

According to a third aspect, a charging system is further provided. The charging system includes a power supply end and the electronic device. The power supply end is configured to convert the AC signal into a DC signal, and output the DC signal to the electronic device. The electronic device includes the charging circuit and the electricity-consuming apparatus. The charging circuit includes the resonant circuit and the voltage transformer circuit. The resonant circuit is configured to convert the received DC signal into another AC signal. The voltage transformer circuit includes the primary winding and the secondary winding. The primary winding is connected to the output end of the resonant circuit. The primary winding and the secondary winding are coupled to each other. The voltage transformer circuit is configured to obtain the second voltage by transforming the first voltage of the another AC signal through the primary winding and the secondary winding. The second voltage is configured to supply the electrical energy to the electricity-consuming apparatus. The second voltage is less than or equal to the first voltage. The resonant circuit is configured to operate at a constant resonant frequency.

### BRIEF DESCRIPTION OF THE DRAWINGS

FIG. 1A is a schematic diagram illustrating the operation of a charge pump circuit in the related art during a first half of an operating cycle.

FIG. 1B is a schematic diagram illustrating the operation of the charge pump circuit in the related art during a second half of an operating cycle.

FIG. 2 is a first schematic structural composition diagram of a charging circuit in some embodiments of the present disclosure.

FIG. 3 is a second schematic structural composition diagram of the charging circuit in some embodiments of the present disclosure.

FIG. 4 is a third schematic structural composition diagram of the charging circuit in some embodiments of the present disclosure.

FIG. 5 is a fourth schematic structural composition diagram of the charging circuit in some embodiments of the present disclosure.

FIG. 6 is a fifth schematic structural composition diagram of the charging circuit in some embodiments of the present disclosure.

FIG. 7 is a sixth schematic structural composition diagram of the charging circuit in some embodiments of the present disclosure.

FIG. 8 is a first schematic structural composition diagram of an electronic device in some embodiments of the present disclosure.

FIG. 9 is a second schematic structural composition diagram of the electronic device in some embodiments of the present disclosure.

FIG. 10 is a third schematic structural composition diagram of the electronic device in some embodiments of the present disclosure.

FIG. 11 is a fourth schematic structural composition diagram of the electronic device in some embodiments of the present disclosure.

FIG. 12 is a schematic structural composition diagram of a charging system in some embodiments of the present disclosure.

FIG. 13 is a schematic flowchart of a charging control method in some embodiments of the present disclosure.

### DETAILED DESCRIPTION

To describe the features and technical aspects of embodiments of the present disclosure more thoroughly, the following is a detailed description of the implementation of the embodiments of the present disclosure in conjunction with the accompanying drawings, which are for illustrative purposes only and are not intended to limit the embodiments of the present disclosure.

The terms “first,” “second” or etc. in the specification, the claim set, and the figures of the present disclosure are used for distinguishing between different objects, and are not used for describing a particular sequential order. In addition, the terms “include”, “comprise” and any variations thereof are intended to cover non-exclusive inclusion. For example, a process, a method, a system, a product, or a device that includes a series of operations or units is not limited to the listed operations or units, but optionally includes unlisted operations or units, or optionally also includes other operations or units inherent to these processes, methods, products, or devices.

To facilitate understanding of the technical schemes of the embodiments of the present disclosure, the relevant technologies of embodiments of the present disclosure are described below, and the following relevant technologies may be arbitrarily combined with the technical schemes of the embodiments of the present disclosure as an optional scheme, and they all belong to the protection scope of the embodiments of the present disclosure.

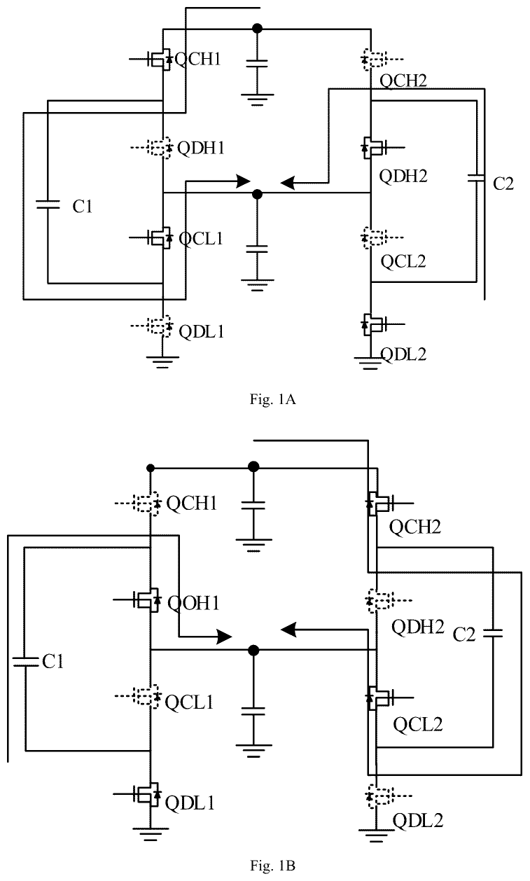

In an actual application, a charging circuit of a smart terminal is a charge pump (CP) circuit. The CP circuit is configured to halve an input voltage by continually turning on a switch to charge capacitors and turning off the switch to redistribute charges among the capacitors, and configured to supply the halved voltage to a battery for charging. As illustrated in schematic circuit diagrams of FIGS. 1A and 1B, FIG. 1A is a schematic diagram illustrating an operation of the CP circuit during a first half of one operating cycle, and FIG. 1B is a schematic diagram illustrating the operation of the CP circuit during a second half of the one operating cycle.

For example, as illustrated in FIG. 1A, the CP circuit is configured to, during the first half of the cycle, turn on switch tubes QCH1, QCL1, QDH2, and QDL2, and to charge a capacitor C1 and a capacitor C2. A series voltage of the capacitor C1 and the capacitor C2 is VDD. As illustrated in FIG. 1B, the CP circuit is configured to, during the second half of the cycle, turn on switch tubes QDH1, QDL1, QCH2, and QCL2, to redistribute charges between the capacitor C1 and the capacitor C2, thereby bringing an intermediate voltage approaching ½VDD. After a plurality of cycles, an output voltage is stabilized to ½VDD, thus realizing a voltage-halving function.

Due to advantages such as easy setup and high efficiency, the CP circuits are widely used by customers. Since halving the voltage by the CP circuit would result in a multiplication of electrical current, the electrical current in the CP circuit would rise as the charging power rises. Further, the switch tubes and capacitors in the CP circuit would age or degrade over time, resulting in short-circuiting or open-circuiting of these devices, thereby increasing the output voltage. Moreover, the capacitors are directly connected in parallel with the battery. When the battery's voltage exceeds a threshold value, there is a risk of fire and explosion, thus the existing CP charging technologies are unable to meet the reliability requirements. In addition, as the power of an external power supply end increases, an output current of the external power supply end would also increase, and the impedance of a cable wire is required to be less. The diameter of the cable wire thus needs to be increased, which would cause a problem of high hardware cost.

Based on the above-mentioned problem, a charging circuit is provided according to some embodiments of the present disclosure. The charging circuit specifically includes a resonant circuit and a voltage transformer circuit. The resonant circuit is configured to convert a received DC signal into an AC signal. The voltage transformer circuit includes a primary winding and a secondary winding. The primary winding is connected to an output end of the resonant circuit. The primary winding and the secondary winding are coupled to each other. The voltage transformer circuit is configured to obtain a second voltage by transforming a first voltage of the AC signal through the primary winding and the secondary winding. The second voltage is less than or equal to the first voltage. The second voltage is configured to supply electrical energy or power to an electricity-consuming apparatus. It can be seen that, for the charging circuit provided in some embodiments of the present disclosure, the electricity-consuming apparatus and an external power supply end may be isolated from each other through a coupling relationship between the windings. In this way, a high power and high voltage output from an adapter is subjected to isolation and bucking process by the primary winding and the secondary winding in the voltage transformer circuit, the voltage of the electricity-consuming apparatus may be maintained in a stable state, thereby improving the reliability of the charging circuit. In this way, the charging circuit provided by embodiments of the present disclosure may enhance a charging power while ensuring the reliability of the devices.

The charging circuit provided in some embodiments of the present disclosure may be applied to an electronic device provided in some embodiments of the present disclosure. The electronic device is a receiving end of the electrical energy being charged. The electronic devices provided by embodiments of the present disclosure may include a cell phone, a mobile power supply, a battery electric vehicle, a laptop computer, an unmanned aerial vehicle, a tablet computer, an e-book reader, an electronic cigarette, a wearable device (e.g., a watch, a bracelet, smart glasses, etc.), a robot (e.g., a robot cleaner, a washing machine, etc.), a wireless headset, a Bluetooth speaker, a wireless mouse, etc. Embodiments of the present disclosure do not impose any limitation on the kind of the electronic device. In addition, the adapter in some embodiments of the present disclosure is a supply end or resource end of the electrical energy being charged.

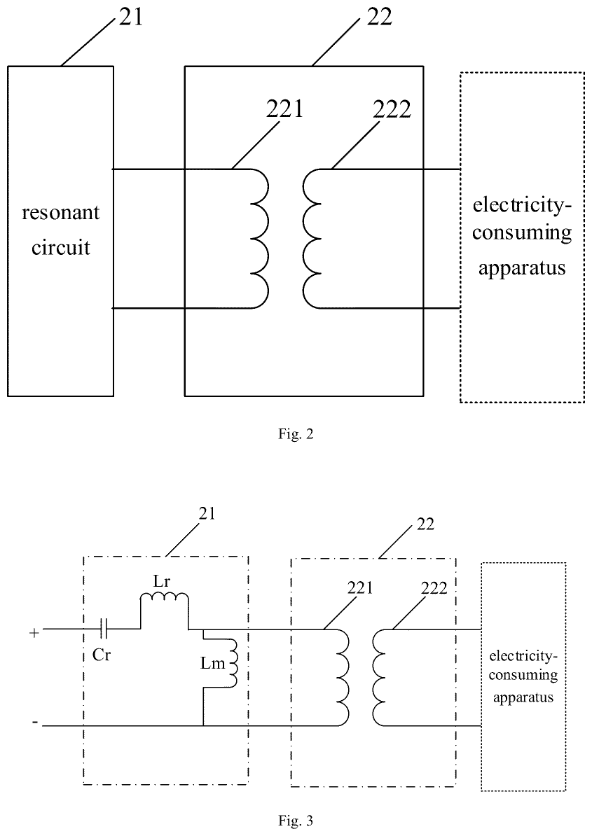

As illustrated in FIG. 2, the charging circuit is provided in some embodiments of the present disclosure. The charging circuit may include a resonant circuit 21 and a voltage transformer circuit 22. The voltage transformer circuit 22 includes a primary winding 221 and a secondary winding 222. The primary winding 221 and the secondary winding 222 are coupled to each other.

The output end of the resonant circuit 21 is connected to the primary winding 221 of the voltage transformer circuit 22. An input of the resonant circuit 21 may receive a direct current (DC) signal provided by the external power supply end. The external power supply is for example a charger, an adapter, etc. The resonant circuit 21 is configured to convert the received DC signal into an alternating current (AC) signal. In this way, the AC signal converted by the resonant circuit 21 may drive the primary winding 221 and the secondary winding 222 of the voltage transformer circuit 22 to generate electromagnetic induction, thereby stepping down or bucking the first voltage to the second voltage. In other words, the voltage transformer circuit 22 may be a DC voltage transformer DCX.

The secondary winding 222 of the voltage transformer circuit 22 may be connected to the electricity-consuming apparatus. After the voltage transformer circuit 22 has converted the first voltage to the second voltage, the charging circuit may supply power to the electricity-consuming apparatus at the second voltage.

In some embodiments, the electricity-consuming apparatus may be a battery, a processor, a display screen, or other devices that require to consume electrical energy, which is not limited in embodiments of the present disclosure.

For the charging circuit provided in some embodiments of the present disclosure, the voltage input to the charging circuit from the external power supply end may be greater than a input voltage in the related art. For example, the voltage input to the charging circuit from the external power supply end may be greater than 30 volts (V). The external power supply end is isolated from the electricity-consuming apparatus by the coupling relationship between the primary winding 221 and the secondary winding 222 in the voltage transformer circuit 22. The secondary winding 222 would not be directly connected to the primary winding 221, so the high input voltage would not affect the electricity-consuming apparatus connected to the secondary winding side. For an electronic device adopting the charging circuit according to some embodiments of the present disclosure, the voltage input to the charging circuit from the external charging end may be higher. While the charging power at the external charging end is a certain value, the current input to the charging circuit may be smaller, which may improve the efficiency of the charging system, and allow the diameter of the cable wire between the external charging end and the charging circuit to be reduced. In this way, the cable wire may be thinner, the cost of the cable wire may be reduced, and the trouble of high-power charging may thus be solved fundamentally.

It thus can be seen that, for the charging circuit provided in some embodiments of the present disclosure, the external power supply end is isolated from the electricity-consuming apparatus by the coupling relationship between the primary winding 221 and the secondary winding 222. In this way, the high power and high voltage output from the external power supply end is subjected to isolation and bucking by the primary winding and the secondary winding in the voltage transformer circuit, the voltage of the electricity-consuming apparatus may be maintained in a stable state, thereby improving the reliability of the charging circuit. In this way, the charging circuit provided by embodiments of the present disclosure may enhance the charging power while ensuring the reliability of the device.

In some embodiments, compared to the related technologies in which the operating frequency of the resonant circuit varies with the load, the resonant circuit 21 in the embodiment of the present disclosure may operate at a constant resonant frequency. In other words, the resonant circuit 21 may remain operating at a resonant frequency. In this way, an impedance of the resonant circuit 21 may be minimized, thereby maximizing the gain of the input voltage and the output voltage of the resonant circuit, and improving the charging efficiency of the charging circuit.

In other words, the resonant circuit 21 may maintain operating at the resonant frequency, thereby maximizing the gain of the input voltage and the output voltage of the resonant circuit 21, and improving the charging efficiency of the charging circuit. In this way, the charging circuit provided by embodiments of the present disclosure may enhance the charging power and the charging efficiency, while ensuring the reliability of the device at the same time.

In some embodiments of the present disclosure, the ratio between the number of turns of the primary winding 221 to the number of turns of the secondary winding 222 is N:1. N is a number greater than or equal to 1.

The ratio between the number of turns of the primary winding 221 to the number of turns of the secondary winding 222 has an association relationship with the first voltage and the second voltage. The ratio between the number of turns of the primary winding 221 to the number of turns of the secondary winding 222 is identical or equal to the ratio between the first voltage to the second voltage.

In other words, the ratio between the number of turns of the primary winding 221 to that of the secondary winding 222 may be designed according to different charging requirements, such that the first voltage of the AC signal output from the resonant circuit 21 may be transformed to a suitable second voltage for powering the electricity-consuming apparatus. As an example, if the output power of the external power supply end is boosted to 200 W, and the first voltage is boosted to 20V, the number of turns of the primary winding 221 may be designed to be 4 times the number of turns of the secondary winding 222, and the second voltage may be 5V.

It thus can be seen that, in the charging circuit provided in some embodiments of the present disclosure, a voltage distribution may be achieved by the windings of the primary winding 221 and the secondary winding 222. When the external power supply end outputs a higher power (e.g., greater than 150 W) and a higher voltage (e.g., 30-50V), the resonant circuit 21 and the voltage transformer circuit 22 may perform different voltage transformation, so as to supply power to the electricity-consuming apparatus.

In some embodiments of the present disclosure, as illustrated in FIG. 3, the resonant circuit 21 may include a resonant capacitor Cr, a resonant inductor Lr, and a magnetizing inductor Lm that are connected in series. A first end of the primary winding 221 is connected to both a second end of the resonant inductor Lr and a first end of the magnetizing inductor Lm. A second end of the primary winding 221 is connected to a second end of the magnetizing inductor Lm.

In some embodiments, the magnetizing inductor Lm may share a same structure as the primary winding 221. In other words, in some embodiments of the present disclosure, corresponding functions of the magnetizing inductor may also be achieved by the primary winding 221, thereby eliminating the need for an additional inductor.

In some embodiments of the present disclosure, the resonant circuit may be an LLC resonant circuit. The LLC resonant circuit and the voltage transformer circuit form a DCX-LLC resonant converter. The present disclosure may retain the advantages of traditional DCX-LLC resonant converters, and enables a high efficiency over a wide range.

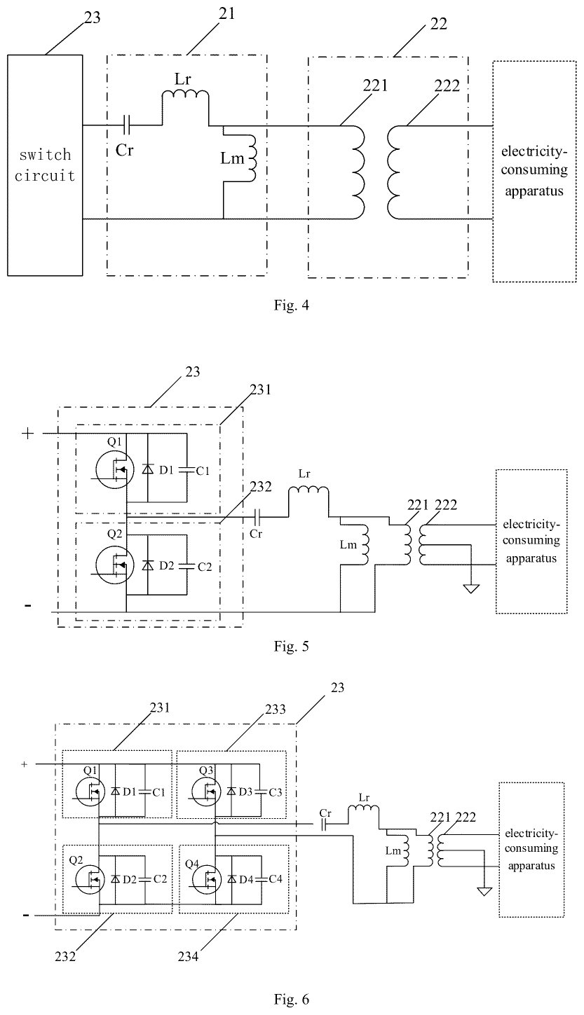

As illustrated in FIG. 4, the charging circuit provided in some embodiments of the present disclosure may further include a switch circuit 23. An output end of the switch circuit 23 may be connected to an input end of the resonant circuit 21.

The switch circuit 23 includes at least two switch units. The switch circuit 23 is configured to alternatively turn on a first set of switch units and a second set of switch units of the at least two switch units according to a switching frequency, thereby allowing the resonant circuit to convert the received DC signal into the AC signal. The switching frequency is determined based on the resonant frequency.

In the embodiments of the present disclosure, the switch circuit 23 may include two or more than two switch units. For example, the switch circuit 23 may include two switch units, four switch units or six switch units etc., which is not limited in embodiments of the present disclosure.

The at least two switch units in the switch circuit 23 may be divided into two parts: the first set of switch units and the second set of switch unit. Each set of switch units includes at least one switch unit. As an example, the number of the switch units in the switch circuit 23 may be an even number. In this way, the first set of switch units may include the same number of switch units as the second set of switch units.

By alternatively turning on the first set of switch units and the second set of switch units of the switch circuit 23, the switch circuit 23 may drive the resonant circuit 21 to convert the received DC signal into the AC signal. The first set of switch units and the second set of switch units may alternately turn off and turn on according to a certain switching frequency.

In other words, in some embodiments of the present disclosure, the charging circuit may convert, through controlling the switching frequency of each switch unit in the switch circuit 23, the received DC signal into the AC signal.

The switching frequency may be related to the resonant frequency at which the resonant circuit 21 operates. The charging circuit enables, by controlling the frequencies of turning on and off of each switch unit in the switch circuit 23, the resonant circuit 21 to operate at different frequencies. In actual application, to ensure that the resonant circuit 21 always operates at the resonant frequency, and to maximize the gain, the switching frequencies may be designed based on the resonant frequency.

In the embodiments of the present disclosure, by setting the switching frequency of the switch units in the switch circuit 23 as the resonant frequency, the resonant circuit 21 may be enabled to always operate at the resonant frequency, thereby achieving the high-frequency operation of the resonant circuit 21, and improving the charging efficiency.

Based on the above-mentioned embodiments, in some embodiments of the present disclosure, a topology of the switch circuit 23 may be a half-bridge topology. As illustrated in the schematic structural diagram of the half-bridge DCX-LLC charging circuit of the FIG. 5, the switch circuit 23 may include a first switch unit 231 and a second switch unit 232. The above-mentioned first set of switch units may include the first switch unit 231. The above-mentioned second set of switch units may include the second switch unit 232.

The first switch unit 231 may constitute the above-mentioned first set of switch unit, and the second switch unit 232 may constitute the above-mentioned second set of switch unit. In some embodiments of the present disclosure, the switch circuit 23 is configured to alternatively turn on the first switch unit and the second switch unit according to the switching frequency, thereby allowing the resonant circuit to convert the received DC signal into the AC signal.

The first switch unit 231 is connected in series with the second switch unit 232. A first end of the first switch unit 231 is connected to a positive voltage input port of a charging interface. A second end of the first switch unit 231 is connected to a first end of the second switch unit 232. The second end of the second switch unit 232 is connected to a negative voltage input port of the charging interface. A first input end of the resonant circuit 23 is connected to both the second end of the first switch unit 231 and a first end of the second switch unit 232. A second input end of the resonant circuit 23 is connected to the second end of the second switch unit 232.

In some embodiments of the present disclosure, a charging link may also include the charging interface. The charging interface may be connected to the external power supply end through a charging wire, for receiving an incoming DC signal. The charging wire may be the cable wire. The charging interface includes the positive voltage input port and the negative voltage input port.

In some embodiments, the charging interface is a Type-C interface. The charging interface may also be any interface that includes power pins Vbus and GND.

In addition, in the embodiments of the present disclosure, a first input end of the resonant circuit 21 may be a first end of the resonant capacitor Cr, and a second input end of the resonant circuit 21 may be a second end of the magnetizing inductor Lm.

The input voltage of the resonant circuit 21 may be a midpoint voltage of the switch circuit 23. In some embodiments of the present disclosure, the midpoint voltage of the switch circuit 23 may be the voltage at a connection point between the second end of the first switch unit 231 and the first end of the second switch unit 232.

In some embodiments of the present disclosure, the switch circuit 23 illustrated in FIG. 5 may also step down or buck the voltage supplied by the external power supply end. Under the alternating turning on and turning off operation of the first switch unit and the second switch unit, the midpoint voltage of the charging circuit (i.e., the voltage at the connection point between the first switch unit and the second switch unit) may be half of the input voltage at the charging interface.

As an example, as illustrated in the schematic structural diagram of the half-bridge DCX-LLC charging circuit of the FIG. 5, when a 40V voltage is provided by the external power supply end, the midpoint voltage of the switch circuit 23 may be 20V. If the number of turns of the primary winding 221 is 4 times that of the secondary winding 222, the voltage transformer circuit 22 may reduce the 20V voltage to 5V voltage, resulting in a charging voltage of 5V for the electricity-consuming apparatus.

In the embodiments of the present disclosure, each switch unit may include a switch tube, a first diode, and a first capacitor. In each switch unit, the switch tube, the first diode, and the first capacitor are connected in parallel. Specifically, a source of the switch tube is connected to both a positive electrode of the first diode and a first end of the first capacitor. A drain of the switch tube is connected to both a negative electrode of the first diode and a second end of the first capacitor. In addition, the drain of the switch tube, the negative electrode of the first diode, and the second end of the first capacitor together constitute the first end of the switch unit. The source of the switch tube, the positive electrode of the first diode, and the first end of the first capacitor together constitute the second end of the switch unit.

In the embodiments of the present disclosure, the switch tube and the first diode in each switch unit may be separately provided or integrated together. which is not limited in embodiments of the present disclosure.

For example, as illustrated in FIG. 5, the first switch unit 231 may include a switch tube Q1, a first diode D1 and a first capacitor C1. The second switch unit 232 may include a switch tube Q2, a first diode D2 and a first capacitor C2.

The switch tube Q1 and the switch tube Q2 are connected in series. The source of the switch tube Q1 is connected to the drain of the switch tube Q2. In addition, the switch tube Q1, the first diode D1 and the first capacitor C1 are connected in parallel. The switch tube Q2, the first diode D2 and the first capacitor C2 are connected in parallel.

In addition, the source of the switch tube Q1 is connected to both the positive electrode of the first diode D1 and the first end of the first capacitor C1. The drain of the switch tube Q1 is connected to both the negative electrode of the first diode D1 and the second end of the first capacitor C1. In addition, the source of the switch tube Q2 is connected to both the positive electrode of the first diode D2 and the first end of the first capacitor C2. The drain of the switch tube Q2 is connected to both the negative electrode of the first diode D2 and the second end of the first capacitor C2.

The drain of the switch tube Q1 is also connected to a positive voltage port of the charging interface. The source of the switch tube Q2 is also connected to the negative voltage port of the charging interface.

In some embodiments of the present disclosure, when the switch tube Q2 is turned off, the first diode D2 may be turned on under the effect of the first capacitor C2, thereby turning on the diode Q1. Similarly, when the switch tube Q1 is turned off, the first diode D1 may be turned on under the effect of the first capacitor C1, thereby turning on the diode Q2. In this way, the switch tube Q1 and the switch tube Q2 are turned on at zero voltage, which improves the charging efficiency.

The switch tube Q1 and the first diode D1 may be separately provided or integrated together, and the switch tube Q2 and the first diode D2 may be separately provided or integrated together, which are not limited in embodiments of the present disclosure.

In some embodiments of the present disclosure, the topology of the switch circuit 23 may also be a full-bridge topology. As illustrated in the schematic structural diagram of the full-bridge DCX-LLC charging circuit of the FIG. 6, the switch circuit 23 includes four switch units, namely the first switch unit 231, the second switch unit 232, a third switch unit 233, and a fourth switch unit 234. The first set of switch units includes the first switch unit 231 and the fourth switch unit 234. The second set of switch units includes the second switch unit 232 and the third switch unit 233.

In other words, the first switch unit 231 and the fourth switch unit 234 serve as one set of switch units, the second switch unit 232 and the third switch unit 233 serve as another one set of switch units, and the two sets of switch units are turned on alternately for operation.

The first switch unit 231 is connected in series with the second switch unit 232. The third switch unit 233 is connected in series with the fourth switch unit 234. A combination of the first switch unit 231 and the second switch unit 232 is connected in parallel with a combination of the third switch unit 233 and the fourth switch unit 234.

The first end of the first switch unit 231 and a first end of the third switch unit 233 is connected to the positive voltage input port of the charging interface. The second end of the first switch unit 231 is connected to the first end of the second switch unit 232. The second end of the third switch unit 233 is connected to a first end of the fourth switch unit 234. Each of the second end of the second switch unit 232 and a second end of the fourth switch unit 234 is connected to the negative voltage input port of the charging interface.

In addition, the first input end of the resonant circuit 21 is connected to both the second end of the first switch unit 231 and the first end of the second switch unit 232. The second input end of the resonant circuit 21 is connected to both the second end of the third switch unit 233 and the first end of the fourth switch unit 234

In some embodiments of the present disclosure, the charging link may further include the charging interface. The charging interface may be connected to an external power supply end through a cable wire, for receiving an incoming DC electrical signal from the external power supply end. The charging interface includes the positive voltage input port and the negative voltage input port.

In some embodiments, the charging interface is a Type-C interface.

In addition, in some embodiments of the present disclosure, the first input end of the resonant circuit 21 may be the first end of the resonant capacitor Cr, and the second input end of the resonant circuit 21 may be the second end of the magnetizing inductor Lm.

The input voltage of the resonant circuit 21 may be a midpoint voltage of the switch circuit 23. In some embodiments of the present disclosure, the midpoint voltage of the switch circuit 23 may be a voltage at a connection point between the second end of the first switch unit 231 and the first end of the second switch unit 232, and/or a voltage at a connection point between the second end of the third switch unit 233 and the first end of the fourth switch unit 234. In the full-bridge topology, the midpoint voltage is the same as a voltage input at the charging interface.

In the embodiments of the present disclosure, each switch unit may include a switch tube, a first diode, and a first capacitor. In each switch unit, the switch tube, the first diode, and the first capacitor are connected in parallel. Specifically, the source of the switch tube is connected to both the positive electrode of the first diode and the first end of the first capacitor. The drain of the switch tube is connected to both the negative electrode of the first diode and the second end of the first capacitor. In addition, the drain of the switch tube, the negative electrode of the first diode, and the first end of the first capacitor together constitute the first end of the switch unit. The source of the switch tube, the positive electrode of the first diode, and the second end of the first capacitor together constitute the second end of the switch unit.

In some embodiments of the present disclosure, the switch tube and the first diode in each switch unit may be separately provided or integrated together, which is not limited in the embodiments of the present disclosure.

As illustrated in FIG. 6, the first switch unit 231 may include a switch tube Q1, a first diode D1 and a first capacitor C1. The second switch unit 232 may include a switch tube Q2, a first diode D2 and a first capacitor C2. The third switch unit 233 may include a switch tube Q3, a first diode D3 and a first capacitor C3. The fourth switch unit 234 may include a switch tube Q4, a first diode D4 and a first capacitor C4.

The switch tube Q1 and the switch tube Q2 are connected in series. The source of the switch tube Q1 is connected to the drain of the switch tube Q2. In addition, the switch tube Q3 and the switch tube Q4 are connected in series. The source of the switch tube Q3 is connected to the drain of the switch tube Q4.

In addition, the switch tube Q1, the first diode D1 and the first capacitor C1 are connected in parallel. The switch tube Q2, the first diode D2 and the first capacitor C2 are connected in parallel. The switch tube Q3, the first diode D3 and the first capacitor C3 are connected in parallel. The switch tube Q4, the first diode D4 and the first capacitor C4 are connected in parallel.

In some embodiments of the present disclosure, the source of the switch tube Q1 is connected to both the positive electrode of the first diode D1 and the first end of the first capacitor C1. The drain of the switch tube Q1 is connected to the negative electrode of the first diode D1 and the second end of the first capacitor C1. The source of the switch tube Q2 is connected to both the positive electrode of the first diode D2 and the first end of the first capacitor C2. The drain of the switch tube Q2 is connected to the negative electrode of the first diode D2 and the second end of the first capacitor C2. The source of the switch tube Q3 is connected to the positive electrode of the first diode D3 and the first end of the first capacitor C3. The source of the switch tube Q3 is connected to the negative electrode of the first diode D3 and the second end of the first capacitor C3. The source of the switch tube Q4 is connected to the positive electrode of the first diode D4 and the first end of the first capacitor C4. The drain of the switch tube Q4 is connected to the negative electrode of the first diode D4 and the second end of the first capacitor C4.

Each of the drain of the switch tube Q1 and the drain of the switch tube Q3 is further connected to the positive voltage port of the charging interface. Each of the source of the switch tube Q2 and the source of the switch tube Q4 is further connected to the negative voltage port of the charging interface.

In some embodiments of the present disclosure, when the switch tube Q2 and the switch tube Q3 are turned off, the first diode D1 and the first diode D4 may be turned on through the action of the first capacitor C2 and the first capacitor C3 and thereby turn on the diode Q1 and the diode Q4. Similarly, when the switch tube Q1 and the switch tube Q4 are turned off, the first diode D2 and the first diode D3 may be turned on through the action of the first capacitor C1 and the first capacitor C4 and thereby turn on the diode Q2 and the switch tube Q3. In this way, the switch tube Q1 to the switch tube Q4 are turned on at zero voltage, which improves the charging efficiency.

In the embodiments of the present disclosure, the switch tube Q1 and the first diode D1 may be separately provided or integrated together. The switch tube Q2 and the first diode D2 may be separately provided or integrated together. The switch tube Q3 and the first diode D3 may be separately provided or integrated together. The switch tube Q4 and the first diode D4 may be separately provided or integrated together. These are not limited in embodiments of the present disclosure.

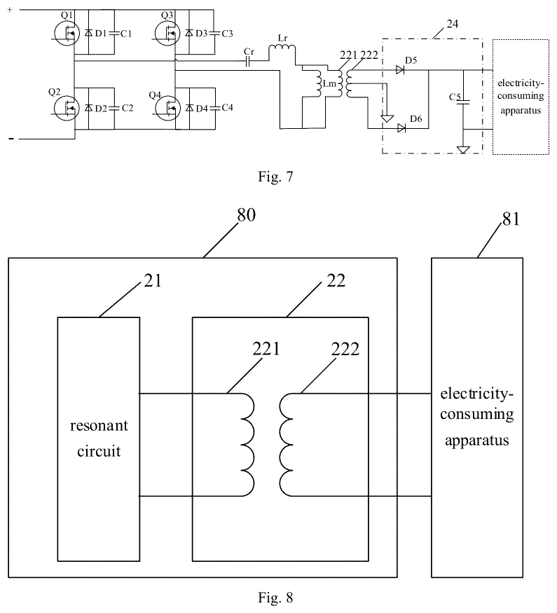

In some embodiments of the present disclosure, as illustrated in FIG. 7, the charging circuit provided may further include a rectifier circuit 24. The rectifier circuit 24 is connected to the output end of the voltage transformer circuit 22. The rectifier circuit 24 is configured to rectify the second voltage to obtain a supply voltage. The supply voltage is configured to provide electrical energy to the electricity-consuming apparatus.

The input end of the rectifier circuit 24 may be connected to the secondary winding 222 of the voltage transformer circuit 22. The output end of the rectifier circuit 24 may be connected to the electricity-consuming apparatus. The second voltage obtained after a voltage step-down process of the voltage transformer circuit 22 is AC electrical energy. In some embodiments of the present disclosure, the rectifier circuit 24 may convert the second voltage of the AC energy into the supply voltage of the DC energy. In this way, the charging circuit may supply power to the electricity-consuming apparatus with the obtained supply voltage.

In some embodiments of the present disclosure, the rectifier circuit 24 may include at least two second diodes and a second capacitor. The rectifier circuit 24 may be a half-wave rectifier circuit, a full-wave rectifier circuit, or a bridge-type rectifier circuit, which is not limited in embodiments of the present disclosure.

As an example, as illustrated in FIG. 7, the rectifier circuit 24 may include a second diode D5, a second diode D6 as well as a second capacitor C5. A positive electrode of the second diode D5 is connected to a first end of the secondary winding 222. A negative electrode of the second diode D5 is connected to a first end of the second capacitor C5. The positive electrode of the second diode D6 is connected to a second end of the secondary winding 222. A negative electrode of the second diode D6 is connected to both a negative electrode of the second diode D5 and the first end of the second capacitor C5. A second end of the second capacitor C5 is grounded. In addition, the electricity-consuming apparatus may be connected in parallel with the second capacitor C5.

In the embodiments of the present disclosure, the charging circuit may exploit the rectifier circuit 24 to output a rectified signal, so as to achieve switching at zero current and high charging efficiency over a wide range.

In summary, at this stage, with the development trend of high-power adapters, how to increase the charging power while ensuring the reliability of the charging circuit is the key issue to be considered at present. In comparison with the CP architecture, the resonant circuit and the voltage transformer circuit architecture (i.e., the LLC-DCX architecture) provided by embodiments of the present disclosure has an advantage of natural power isolation. In the event of abnormalities, damages, breakdowns, or etc. of the system devices, the LLC-DCX architecture may enable natural power isolation. Further, the breakdown voltages of the voltage transformer circuits are much higher than those of the switch tubes and capacitive elements, and the reliability is greatly improved.

An electronic device is further provided according to some embodiments of the present disclosure. As illustrated in FIG. 8, the electronic device may include a charging circuit 80 and an electricity-consuming apparatus 81. The charging circuit 80 may include the resonant circuit 21 and the voltage transformer circuit 22. The voltage transformer circuit 22 includes the primary winding 221 and the secondary winding 222. The primary winding 221 and the secondary winding 222 are coupled to each other.

The output end of the resonant circuit 21 is connected to the primary winding 221 of the voltage transformer circuit 22. The secondary winding 222 of the voltage transformer circuit 22 is connected to the electricity-consuming apparatus 81.

Those skilled in the art should appreciate that, the related description of the above-mentioned electronic device in embodiments of the present disclosure may be referred to the related description of the charging circuit in embodiments of the present disclosure for appreciation.

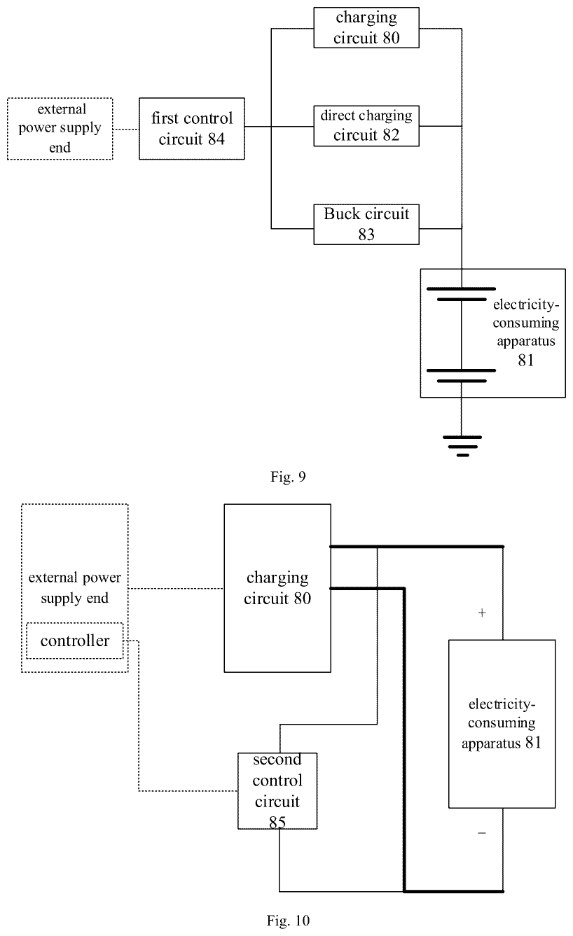

In some embodiments of the present disclosure, as illustrated in FIG. 9, the electronic device may further include: a direct charging circuit 82, a voltage step-down type converter BUCK circuit 83, and a first control circuit 84.

The first control circuit 84 is configured to obtain charging state information of the electricity-consuming apparatus 81, and select, based on the charging state information, any one of the charging circuit 80, the direct charging circuit 82, and the BUCK circuit 83 for supplying power to the electricity-consuming apparatus 81.

During the process of powering the electricity-consuming apparatus 81, a charging state of the electricity-consuming apparatus 81 may be detected, and a suitable circuit may be selected to power the electricity-consuming apparatus 81.

In some embodiments, the charging state information may include the voltage, the current, and the charging power across the two ends of the electricity-consuming apparatus 81, as well as the temperature of the electricity-consuming apparatus 81, the electric capacity of the electricity-consuming apparatus 81 or etc., which is not limited in embodiments of the present disclosure.

As an example, when the charging state information indicates that the charging power across the two ends of the electricity-consuming apparatus 81 is greater than a first power threshold (e.g., 150 W) and/or the voltage across the two ends of the electricity-consuming apparatus 81 is greater than a first voltage threshold (e.g., 30V), the electronic device may select the charging circuit 80 provided by the embodiments of the present disclosure to supply power to the electricity-consuming apparatus 81. When the charging state information indicates that the charging power across the two ends of the electricity-consuming apparatus 81 is less than the first power threshold and the voltage across the two ends of the electricity-consuming apparatus 81 is less than the first voltage threshold, the direct charging circuit 82 or the BUCK circuit 83 may be selected to power the electricity-consuming apparatus 81.

In some embodiments of the present disclosure, the electricity-consuming apparatus 81 may be a battery module or any device that requires usage of electrical energy, which is not limited in embodiments of the present disclosure. When the electricity-consuming apparatus 81 is the battery module, the battery module may include at least one battery, which may be a nickel-metal hydride battery or a lithium-ion battery, and is not limited in embodiments of the present disclosure. As an example, as illustrated in FIG. 9, the electricity-consuming apparatus 81 may include two batteries in series, and another number of batteries may be further included in the electricity-consuming apparatus 81, which is not limited in embodiments of the present disclosure. In this scenario, the charging state information obtained by the first control circuit 84 may include parameters such as the voltage, the current, the charging power, the battery temperature, the battery capacity, or etc. of the battery module.

Based on the electronic device as illustrated in FIG. 8, in some embodiments of the present disclosure, as illustrated in FIG. 10, the electronic device may further include a second control circuit 85. The second control circuit 85 is configured to obtain the charging state information of the electricity-consuming apparatus 81. The second control circuit 85 may also have a communication function, so as to send the obtained charging state information to the external power supply end. The charging state information may be used by the external power supply end to adjust the voltage of the DC signal that the external power supply end supplies to the electronic device.

The second control circuit 85 may be a different control circuit from the first control circuit 84. The function of the second control circuit 85 may also be achieved by the first control circuit 84, or the first control circuit 84 and the second control circuit 85 may be integrated into a same control circuit.

In some embodiments of the present disclosure, the external power supply end may be a power supply end capable of dynamically adjusting its output voltage. As an example, in some embodiments of the present disclosure, the external power supply end may be a charger or an adapter with an integrated controller. which is not limited in embodiments of the present disclosure.

In some embodiments, the second control circuit 85 may be connected to a controller of the external power supply end through the cable wire. In some embodiments, the second control circuit 85 is connected to the controller of the external power supply end through a specific interface, which is not limited in embodiments of the present disclosure.

In some embodiments of the present disclosure, the second control circuit 85 may obtain the charging state information of the electricity-consuming apparatus 81 and send the charging state information to the controller of the external power supply end. In this way, the controller of the external power supply end may adjust the voltage of the DC signal supplied by the external power supply end, so as to match the actual power demand of the electricity-consuming apparatus 81 in the electronic device, thereby improving the charging efficiency.

In some other embodiments, after obtaining the charging state information, the second control circuit 85 may also not send such charging state information to the external power supply end. The electronic device may be configured to: determine, based on the charging state information obtained by the second control circuit 85, the voltage demanded by the current electricity-consuming apparatus 81; and, request the demanded voltage directly from the external power supply end via the second control circuit 85. Accordingly, after receiving this request, the controller of the external power supply end directly adjusts, based on the requested voltage, the voltage of the DC signal, enabling the adjusted voltage of the DC signal to match the requested voltage, thereby improving the charging efficiency.

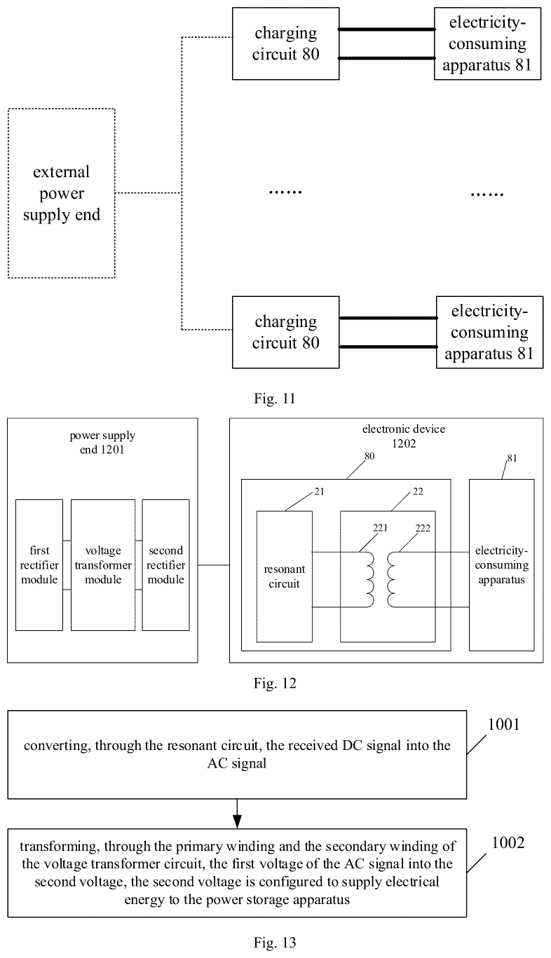

Based on the electronic device as illustrated in FIG. 8, in some embodiments of the present disclosure, as illustrated in FIG. 11, the number of the charging circuits 80 of the electronic device may be more than one, and the number of the electricity-consuming apparatuses 81 of the electronic device may be more than one.

In the embodiments of the present disclosure, a plurality of charging circuits 80 may be connected in parallel with each other. An input end of each charging circuits 80 is connected to the charging interface to receive a DC signal provided by the external power supply end.

In addition, the output ends of the plurality of charging circuits 80 are connected to the plurality of electricity-consuming apparatuses 81, and different charging circuits 80 may supply power to different electricity-consuming apparatuses 81. The functions of different ones of the plurality of electricity-consuming apparatuses 81 may be different. As an example, the plurality of electricity-consuming apparatuses 81 may include a battery module, a display screen, a processor, an image acquisition device, or etc. The types of the plurality of electricity-consuming apparatuses are not limited in the embodiments of the present disclosure.

In some embodiments, the plurality of charging circuits 80 may correspond one-to-one with the plurality of electricity-consuming apparatuses 81. In other words, one charging circuit 80 corresponds to one electricity-consuming apparatus 81. Each charging circuit 80 supplies power to its corresponding electricity-consuming apparatus 81. In addition, the charging circuit 80 and the plurality of electricity-consuming apparatuses 81 may also be in a multiple-to-one relationship. In other words, one charging circuit 80 may supply power to a plurality of electricity-consuming apparatuses 81. The corresponding relationship between the plurality of charging circuits 80 and the plurality of electricity-consuming apparatuses 81 is not limited in the embodiments of the present disclosure.

In some embodiments of the present disclosure, only two charging circuits 80 and two electricity-consuming apparatuses 81 are illustrated in FIG. 11. The electronic device may further include other numbers of charging circuits and electricity-consuming apparatuses, which is not limited in embodiments of the present disclosure.

It thus can be seen that, in some embodiments of the present disclosure, the plurality of power supply circuits 80 in the electronic device are independent of each other, and different charging circuits 80 may be configured to supply power to different electricity-consuming apparatuses 81. In other words, the plurality of electricity-consuming apparatuses 81 may be powered simultaneously to improve the power supply efficiency.

In summary, the electronic device provided in embodiments of the present disclosure may supply power with the DCX-LLC architecture, and may achieve a high efficiency over a wide range. Meanwhile, the DCX-LLC architecture is composed of the primary winding and the secondary winding, which may enable the voltage matching and the electrical isolation, thereby enhancing the system reliability.

For an electronic device adopting the charging circuit according to an embodiment of the present disclosure, the voltage input to the charging circuit from the adapter of the electronic device may be higher. While the charging power at the external power supply end is a certain value, the current input to the charging circuit may be smaller, which may improve the efficiency of the external charging system and allow the diameter of the cable wire between the external charging end and the charging circuit to be reduced. In this way, the cable wire may be thinner, the cost of the cable wire may be reduced, and the trouble of the high-power charging may thus be solved fundamentally.

In addition, the DCX-LLC architecture may achieve a higher frequency, and its compact size may allow an optimization of the entire charging and power supply system, resulting in higher efficiency, smaller volume, and lower cost.

A charging system is further provided according to some embodiments of the present disclosure. As illustrated in FIG. 12, the charging system may include a power supply end 1201 and an electronic device 1202.

The power supply end 1201 is configured to convert the AC signal to the DC signal, and output the DC signal to the electronic device 1202.

The electronic device 1202 includes the charging circuit 80 and the electricity-consuming apparatus 81. The charging circuit 80 includes the resonant circuit 21 and the voltage transformer circuit 22. The resonant circuit 21 is configured to convert the received DC signal into an AC signal. The voltage transformer circuit 22 includes the primary winding 221 and the secondary winding 222. The primary winding 221 is connected to the output end of the resonant circuit 222. The primary winding 221 and the secondary winding 222 are coupled to each other. The voltage transformer circuit 22 is configured to obtain the second voltage by transforming the first voltage of the AC signal through the primary winding 221 and the secondary winding 222. The second voltage is configured to supply the electrical energy to the electricity-consuming apparatus 81. The second voltage is less than or equal to the first voltage.

In some embodiments, the power supply end 1201 may be connected to the electronic device 1202 through the charging wire. The power supply end 1201 may provide the DC signal to the electronic device 1202 through the charging wire.

In some embodiments, as illustrated in FIG. 12, the power supply end 1201 may include a first rectifier module, a voltage transformer module and a second rectifier module. The first rectifier module may rectify the incoming AC current (220V or 110V) into the DC current. The voltage transformer module may transform the rectified DC current. For example, the voltage transformer module may perform a voltage step-down process on the 220V or 110V DC current. The second rectifier module may be configured to perform rectification on the transformed DC current and then output the rectified result, in order to provide the electrical energy to the electronic device.

In actual application, the voltage transformer module in the power supply end 1201 is required to step down or buck the voltages of 220V or 110V to a lower value, for example, the most common 5V, 10V, 20V, etc., and then provide the lower voltage to the electronic devices for charging.

For the electronic device in some embodiments of the present disclosure, the electricity-consuming apparatus inside the electronic device may be isolated from the power supply end through the coupling relationship between the primary winding 221 and the secondary winding 222. In this way, a high power and voltage output from the power supply end is subjected to isolation and bucking process by the primary winding and the secondary winding in the voltage transformer circuit, the voltage of the electricity-consuming apparatus may be maintained in a stable state. The electronic devices thus have a higher charging reliability.

In this way, in some embodiments of the present disclosure, the power supply end 1201 of the charging system may enhance the charging efficiency by providing a higher voltage (e.g., a voltage of 30V or above) to the electronic device. In other words, the power supply end 1201 may select a voltage transformer module configured to step down the voltage to a higher voltage, thereby avoiding the previous usage of a voltage transformer module that configured to step down the voltage to a lower voltage. In this way, the hardware costs are saved, and the structure and space accommodated within the power supply end are optimized. In addition, with the enhancement of the output voltage of the power supply end, while the power is a certain value, the diameter of the charging wire may be reduced. In this way, the cost of the hardware may be further reduced, the trouble of high-power charging may thus be solved fundamentally. Furthermore, the DCX-LLC of the electronic device may achieve a higher frequency, thus the charging efficiency is improved, the cost of the charging system is reduced, and the charging system is further optimized.

In some embodiments, the power supply end 1201 may further include a controller. The controller of the power supply end 1201 may be connected to the second control circuit of the electronic device via the cable wire, or another specific interface.

In some embodiments, the second control circuit 85 may send the obtained charging state information of the electricity-consuming apparatus 81 to the controller of the power supply end. Further, the controller may adjust, based on the obtained charging state information, the voltage of the DC signal output to the electronic device, such that the voltage of the DC signal output from the power supply end 1201 may match the voltage actually demanded by the electricity-consuming apparatus 81 of the electronic device, further improving the charging efficiency.

In some embodiments, after obtaining the charging state information, the second control circuit 85 may also not send such charging state information to the external power supply end. The electronic device may be configured to: determine, based on the charging state information obtained by the second control circuit 85, the voltage demanded by the current electricity-consuming apparatus 81; and, request the demanded voltage directly from the external power supply end via the second control circuit 85. Accordingly, after receiving this request, the controller of the external power supply end directly adjusts, based on the requested voltage, the voltage of the DC signal, enabling the adjusted voltage of the DC signal to match the requested voltage, thereby improving the charging efficiency.

A charging control method is further provided according to some embodiments of the present disclosure. The charging control method may be applied to the charging circuit or the electronic device in the above-mentioned embodiments. The charging control method in some embodiments of the present disclosure may include the operations at blocks illustrated in FIG. 13.

The operation at block 1001: converting, through the resonant circuit, the received DC signal into the AC signal.

The operation at block 1002: transforming, through the primary winding and the secondary winding of the voltage transformer circuit, the first voltage of the AC signal into the second voltage. The second voltage is configured to supply the electrical energy to the electricity-consuming apparatus. The second voltage is less than or equal to the first voltage.

In some embodiments, the operation at block 1001 (i.e., converting, through the resonant circuit, the received DC signal into the AC signal) may be achieved by the following operations: alternatively turning on, based on the switching frequency, the first set of switch units and the second set of switch units of the at least two switch units, enabling the resonant circuit to convert the received DC signal into the AC signal. The switching frequency is determined based on the resonant frequency of the resonant circuit.

In some embodiments, after the operation at block 1002 (i.e., transforming, through the primary winding and the secondary winding of the voltage transformer circuit, the first voltage of the AC signal into the second voltage), the following operation may further be implemented: performing, by the rectifier circuit, rectification on the second voltage and obtaining the supply voltage, for supplying the electrical energy to the electricity-consuming apparatus.

The charging control method provided in some embodiments of the present disclosure may be applied to the electronic device. When the electronic device includes the first control circuit, the following operation may further be implemented: obtaining, by the first control circuit, the charging state information of the electricity-consuming apparatus; selecting, based on the charging state information, any one of the charging circuit, the direct charging circuit, and the BUCK circuit for supplying power to the electricity-consuming apparatus.

In some embodiments, when the electronic device includes the second control circuit, the charging control method in some embodiments of the present disclosure may include the following operations: obtaining, by the second control circuit, the charging state information of the electricity-consuming apparatus; sending, by the second control circuit, the charging state information to the external power supply end, for adjustment, by the external power supply end, of the voltage of the DC signal supplied by the external power supply end.

In some embodiments, when the number of the charging circuits in the electronic device is more than one and the number of the electricity-consuming apparatuses in the electronic device is more than one, the charging control method in some embodiments of the present disclosure may include the following operation: supplying power to different electricity-consuming apparatuses through different charging circuits.

In the embodiments provided in the present disclosure, the disclosed device may also be implemented in other ways. The device embodiments described above are merely illustrative. For example, the division of units is only a logical function division, and there may be other division manners in actual implementations. For example, multiple units or components may be combined or integrated into another system, or some features may be ignored or not implemented. In addition, the couplings, the direct couplings, or the communication connections between the components illustrated or discussed may be indirect couplings or communication connections through some interfaces, devices, or units, and may be electrical, mechanical or of other forms.

The technical schemes described in embodiments of the present disclosure may be combined arbitrarily without causing confliction.

The above are only specific implementations of the present disclosure, and the protection scope of the present disclosure is not limited thereto. Changes or alternations within the technical scope of the present disclosure could easily occur to those skilled in the art, and should be considered to be in the protection scope of the present disclosure. Therefore, the protection scope of the present disclosure should be subject to the appended claims.

What is claimed is:

1. A charging circuit, applied to an electronic device, wherein
the charging circuit comprises:
a resonant circuit, configured to convert a received DC signal into an AC signal;
a voltage transformer circuit, comprising a primary winding and a secondary winding, wherein the primary winding is connected to an output end of the resonant circuit, the primary winding and the secondary winding are coupled to each other, the voltage transformer circuit is configured to transform a first voltage of the AC signal into a second voltage through the primary winding and the secondary winding, the second voltage is configured to supply electrical energy to an electricity-consuming apparatus; the second voltage is less than or equal to the first voltage,
wherein the resonant circuit is configured to operate at a constant resonant frequency.

2. The charging circuit as claimed in claim 1, wherein
the charging circuit further comprises a switch circuit;
an output end of the switch circuit is connected to an input end of the resonant circuit; the switch circuit comprises at least two switch units;
the switch circuit is configured to alternatively turn on, according to a switching frequency, a first set of switch units and a second set of switch units of the at least two switch units; in response to alternatively turning on, by the switch circuit and based on the switching frequency, the first set of switch units and the second set of switch units of the at least two switch units, the resonant circuit converts the received DC signal into the AC signal; and the switching frequency is determined based on a resonant frequency of the resonant circuit.

3. The charging circuit as claimed in claim 2, wherein
the switch circuit comprises a first switch unit and a second switch unit, the first set of switch units comprises the first switch unit, and the second set of switch units comprises the second switch unit;
the first switch unit is connected in series with the second switch unit, a first end of the first switch unit is connected to a positive voltage input port of a charging interface, a second end of the first switch unit is connected to a first end of the second switch unit, a second end of the second switch unit is connected to a negative voltage input port of the charging interface;
a first input end of the resonant circuit is connected to both the second end of the first switch unit and the first end of the second switch unit, a second input end of the resonant circuit is connected to the second end of the second switch unit.

4. The charging circuit as claimed in claim 2, wherein
the switch circuit comprises a first switch unit, a second switch unit, a third switch unit, and a fourth switch unit, a first set of switch units comprises the first switch unit and the fourth switch unit, and a second set of switch units comprises the second switch unit and the third switch unit;
the first switch unit is connected in series with the second switch unit, the third switch unit is connected in series with the fourth switch unit, a combination of the first switch unit and the second switch unit is connected in parallel with a combination of the third switch unit and the fourth switch unit;
each of a first end of the first switch unit and a first end of the third switch unit is connected to a positive voltage input port of a charging interface, a second end of the first switch unit is connected to a first end of the second switch unit, a second end of the third switch unit is connected to a first end of the fourth switch unit, each of a second end of the second switch unit and a second end of the fourth switch unit is connected to a negative voltage input port of the charging interface;
a first input end of the resonant circuit is connected to both the second end of the first switch unit and the first end of the second switch unit, a second input end of the resonant circuit is connected to both the second end of the third switch unit and the first end of the fourth switch unit.

5. The charging circuit as claimed in claim 2, wherein
each of the at least two switch units comprises a switch tube, a first diode and a first capacitor;
the switch tube, the first diode and the first capacitor are connected in parallel, a source of the switch tube is connected to both a positive electrode of the first diode and a first end of the first capacitor, a drain of the switch tube is connected to both a negative electrode of the first diode and a second end of the first capacitor;
the drain of the switch tube, the negative electrode of the first diode, and the second end of the first capacitor together constitute a first end of the switch unit, and the source of the switch tube, the positive electrode of the first diode, and the first end of the first capacitor together constitute a second end of the switch unit.

6. The charging circuit as claimed in claim 1, wherein
the charging circuit further comprises a rectifier circuit;
the rectifier circuit is connected to an output end of the voltage transformer circuit;
the rectifier circuit is configured to perform rectification on the second voltage and obtain a supply voltage, the supply voltage is configured to supply the electrical energy to the electricity-consuming apparatus.

7. The charging circuit as claimed in claim 1, wherein
the resonant circuit comprises: a resonant capacitor, a resonant inductor and a magnetizing inductor that are connected in series;
a first end of the primary winding is connected to both a second end of the resonant inductor and a first end of the magnetizing inductor, and a second end of the primary winding is connected to a second end of the magnetizing inductor.

8. An electronic device, comprising a charging circuit and an electricity-consuming apparatus, wherein
the charging circuit comprises a resonant circuit and a voltage transformer circuit;
the resonant circuit is configured to convert a received DC signal into an AC signal;
the voltage transformer circuit comprises a primary winding and a secondary winding, the primary winding is connected to an output end of the resonant circuit, the primary winding and the secondary winding are coupled to each other, and the secondary winding is connected to the electricity-consuming apparatus;
the voltage transformer circuit is configured to transform a first voltage of the AC signal into a second voltage through the primary winding and the secondary winding, the second voltage is configured to supply electrical energy to the electricity-consuming apparatus, and the second voltage is less than or equal to the first voltage,
wherein the resonant circuit is configured to operate at a constant resonant frequency.

9. The electronic device as claimed in claim 8, wherein
the electronic device further comprises: a direct charging circuit, a voltage step-down type converter BUCK circuit, and a first control circuit;
the first control circuit is configured to: obtain charging state information of the electricity-consuming apparatus; and select, based on the charging state information, any one of the charging circuit, the direct charging circuit, and the BUCK circuit for supplying power to the electricity-consuming apparatus.

10. The electronic device as claimed in claim 8, wherein
the electronic device further comprises a second control circuit;
the second control circuit is configured to: obtain a charging state information of the electricity-consuming apparatus; and send the charging state information to an external power supply end, the external power supply end is configured to adjust a voltage of a DC signal supplied by itself; or
the second control circuit is configured to: obtain the charging state information of the electricity-consuming apparatus; determine, based on the charging state information, a demanded voltage; and, request the demanded voltage from the external power supply end.

11. The electronic device as claimed in claim 8, wherein
the number of the charging circuits is more than one, and the number of the electricity-consuming apparatuses is more than one;
a DC signal from an external power supply end is received through parallel connection between the plurality of charging circuits;
output ends of the plurality of charging circuits are connected to the plurality of electricity-consuming apparatuses, wherein different charging circuits are configured to supply power to different electricity-consuming apparatuses.

12. The electronic device as claimed in claim 8, wherein
the charging circuit further comprises a switch circuit;
an output end of the switch circuit is connected to an input end of the resonant circuit; the switch circuit comprises at least two switch units;
the switch circuit is configured to alternatively turn on, according to a switching frequency, a first set of switch units and a second set of switch units of the at least two switch units; in response to alternatively turning on, by the switch circuit and based on the switching frequency, the first set of switch units and the second set of switch units of the at least two switch units, the resonant circuit converts the received DC signal into the AC signal; and the switching frequency is determined based on a resonant frequency of the resonant circuit.

13. The electronic device as claimed in claim 12, wherein
the switch circuit comprises a first switch unit and a second switch unit, the first set of switch units comprises the first switch unit, and the second set of switch units comprises the second switch unit;
the first switch unit is connected in series with the second switch unit, a first end of the first switch unit is connected to a positive voltage input port of a charging interface, a second end of the first switch unit is connected to a first end of the second switch unit, a second end of the second switch unit is connected to a negative voltage input port of the charging interface;
a first input end of the resonant circuit is connected to both the second end of the first
switch unit and the first end of the second switch unit, a second input end of the resonant circuit is connected to the second end of the second switch unit.

14. The electronic device as claimed in claim 12, wherein the switch circuit comprises a first switch unit, a second switch unit, a third switch unit, and a fourth switch unit, a first set of switch units comprises the first switch unit and the fourth switch unit, and a second set of switch units comprises the second switch unit and the third switch unit;
the first switch unit is connected in series with the second switch unit, the third switch unit is connected in series with the fourth switch unit, a combination of the first switch unit and the second switch unit is connected in parallel with a combination of the third switch unit and the fourth switch unit;
each of a first end of the first switch unit and a first end of the third switch unit is connected to a positive voltage input port of a charging interface, a second end of the first switch unit is connected to a first end of the second switch unit, a second end of the third switch unit is connected to a first end of the fourth switch unit, each of a second end of the second switch unit and a second end of the fourth switch unit is connected to a negative voltage input port of the charging interface;
a first input end of the resonant circuit is connected to both the second end of the first switch unit and the first end of the second switch unit, a second input end of the resonant circuit is connected to both the second end of the third switch unit and the first end of the fourth switch unit.

15. The electronic device as claimed in claim 12, wherein
each of the at least two switch units comprises a switch tube, a first diode and a first capacitor;
the switch tube, the first diode and the first capacitor are connected in parallel, a source of the switch tube is connected to both a positive electrode of the first diode and a first end of the first capacitor, a drain of the switch tube is connected to both a negative electrode of the first diode and a second end of the first capacitor;
the drain of the switch tube, the negative electrode of the first diode, and the second end of the first capacitor together constitute a first end of the switch unit, and the source of the switch tube, the positive electrode of the first diode, and the first end of the first capacitor together constitute a second end of the switch unit.

16. A charging system comprising a power supply end and an electronic device, wherein
the power supply end is configured to convert an AC signal to a DC signal, and output the DC signal to the electronic device;
the electronic device comprises a charging circuit and an electricity-consuming apparatus, the charging circuit comprises a resonant circuit and a voltage transformer circuit, the resonant circuit is configured to convert a received DC signal into another AC signal, the voltage transformer circuit comprises a primary winding and a secondary winding, the primary winding is connected to an output end of the resonant circuit, the primary winding and the secondary winding are coupled to each other, the voltage transformer circuit is configured to transform a first voltage of the another AC signal into a second voltage through the primary winding and the secondary winding, the second voltage is configured to supply electrical energy to the electricity-consuming apparatus, and the second voltage is less than or equal to the first voltage, the resonant circuit is configured to operate at a constant resonant frequency.

17. The charging system as claimed in claim 16, wherein
the power supply end comprises a controller, the electronic device comprises a second control circuit, the controller is connected to the second control circuit;
the second control circuit is configured to: obtain charging state information of the electricity-consuming apparatus; and send the charging state information to the controller;
the controller is configured to: adjust, based on the charging state information, a voltage of the DC signal output to the electronic device; or
the second control circuit is configured to: obtain the charging state information of the electricity-consuming apparatus; determine, based on the charging state information, a demanded voltage; and, request the demanded voltage from the external power supply end;
the controller is configured to: adjust, based on the demanded voltage, the voltage of the DC signal output to the electronic device.

18. The charging system as claimed in claim 16, wherein
the charging circuit further comprises a switch circuit;
an output end of the switch circuit is connected to an input end of the resonant circuit; the switch circuit comprises at least two switch units;
the switch circuit is configured to alternatively turn on, according to a switching frequency, a first set of switch units and a second set of switch units of the at least two switch units; in response to alternatively turning on, by the switch circuit and based on the switching frequency, the first set of switch units and the second set of switch units of the at least two switch units, the resonant circuit converts the received DC signal into the another AC signal; and the switching frequency is determined based on a resonant frequency of the resonant circuit.

19. The charging system as claimed in claim 18, wherein
the switch circuit comprises a first switch unit and a second switch unit, the first set of switch units comprises the first switch unit, and the second set of switch units comprises the second switch unit;
the first switch unit is connected in series with the second switch unit, a first end of the first switch unit is connected to a positive voltage input port of a charging interface, a second end of the first switch unit is connected to a first end of the second switch unit, a second end of the second switch unit is connected to a negative voltage input port of the charging interface;
a first input end of the resonant circuit is connected to both the second end of the first switch unit and the first end of the second switch unit, a second input end of the resonant circuit is connected to the second end of the second switch unit.

20. The charging system as claimed in claim 18, wherein
the switch circuit comprises a first switch unit, a second switch unit, a third switch unit, and a fourth switch unit, a first set of switch units comprises the first switch unit and the fourth switch unit, and a second set of switch units comprises the second switch unit and the third switch unit;
the first switch unit is connected in series with the second switch unit, the third switch unit is connected in series with the fourth switch unit, a combination of the first switch unit and the second switch unit is connected in parallel with a combination of the third switch unit and the fourth switch unit;
each of a first end of the first switch unit and a first end of the third switch unit is connected to a positive voltage input port of a charging interface, a second end of the first switch unit is connected to a first end of the second switch unit, a second end of the third switch unit is connected to a first end of the fourth switch unit, each of a second end of the second switch unit and a second end of the fourth switch unit is connected to a negative voltage input port of the charging interface;
a first input end of the resonant circuit is connected to both the second end of the first switch unit and the first end of the second switch unit, a second input end of the resonant circuit is connected to both the second end of the third switch unit and the first end of the fourth switch unit.
